(19) United States
(12) Patent Application Publication
(10) Pub. No.: US 2020/0353863 A1
(43) Pub. Date: Nov. 12, 2020

(54) METHOD AND SYSTEM TO AVOID VEHICLE COLLISION

(71) Applicant: Lenovo (Singapore) Pte. Ltd., New Tech Park (SG)

(72) Inventors: Arnold S. Weksler, Raleigh, NC (US); John Carl Mese, Cary, NC (US); Mark Patrick Delaney, Raleigh, NC (US); Nathan J. Peterson, Oxford, NC (US); Russell Speight VanBlon, Raleigh, NC (US)

(21) Appl. No.: 16/403,982

(22) Filed: May 6, 2019

(51) Int. Cl. B60Q 9/00; G08G 1/16; G08G 1/01

(52) U.S. Cl. CPC B60Q 9/008; G08G 1/166; G07C 5/08; G08G 1/167; G08G 1/0125; G08G 1/165

(57) ABSTRACT

A computer implemented method, system and computer product are provided. The method is under control of one or more processors configured with specific executable program instructions. The method obtains driver-initiated action (DIA) data indicative of a driving maneuver of a principle vehicle and obtains traffic movement related (TMR) data indicative of a course of an object in an environment at least partially around the principle vehicle. The method analyzes the DIA data and TMR data to determine a potential traffic impact (PTI) condition between the principle vehicle and the object and generates a driver notification of the PTI condition.

### BACKGROUND

Embodiments of the present disclosure generally relate to methods, systems and program products that provide collision avoidance indicators based on driver-initiated action data or traffic movement related data.

Today, vehicles are used daily to transport individuals to and from work, school, events, or the like. Over the years, numerous safety features have been created to reduce risk of injury to the driver and others. These safety features include seat belts, air bags, rear viewing cameras, side cameras, automatic breaking, anti-lock brakes, or the like.

However, despite these developments, numerous driving maneuvers remain high risk endeavors for drivers and others on a roadway. As an example, when making a U-turn, often judging the distance, speed, and acceleration of an on-coming vehicle while attempting to avoid cross traffic can prove to be difficult. Merging into busy highway traffic can also be daunting.

Heretofore, a need remains for improved safety when making difficult driving maneuvers including taking turns across traffic, making U-turns, merging into traffic, or the like. Better assistance for the driver preparing to make these driving maneuvers is desired.

### SUMMARY

In accordance with embodiments herein, a computer implemented method is provided. The method is under control of one or more processors configured with specific executable program instructions. The method obtains driver-initiated action (DIA) data indicative of a driving maneuver of a principle vehicle and obtains traffic movement related (TMR) data indicative of a course of an object in an environment at least partially around the principle vehicle. The method analyzes the DIA data and TMR data to determine a potential traffic impact (PTI) condition between the principle vehicle and the object and generates a driver notification of the PTI condition.

The method may calculate the driving maneuver based on the DIA data. The DIA data indicative of a driver-initiated action may affect a principle vehicle direction or principle vehicle speed. The PTI condition may relate to a potential impact of the principle vehicle with at least one of a secondary vehicle, motorized vehicle, non-motorized vehicle, animal, or human. The DIA data and TMR data may include at least one of identifying when to turn the principle vehicle, determining whether to increase speed to make a turn, or determining not to turn. Obtaining TMR data may include receiving the TMR data from at least one vehicle input device coupled to the one or more processors.

Optionally, the at least one vehicle input device may include at least one of, turn signal, radar, infrared sensors, LIDAR, speed sensors, global positioning system, or steering sensor. The TMR data may include at least one of secondary vehicle speed, amount of turn lanes, secondary vehicle direction, or secondary vehicle distance. Notifying a driver of the PTI condition may include at least one of providing haptic feedback, intermittent light, indicator indicia, color coded display, or audible warning. Providing haptic feedback may include at least one of vibrating a seat or vibrating a steering wheel of the principle vehicle. The driving maneuver may be one of merging into traffic, making a U-turn, or making a left turn.

In accordance with embodiments herein, a system is provided. The system includes a principle vehicle. One or more processors are related to the principle vehicle. An input device is coupled to the one or more processors. A local storage medium stores program instructions accessible by the one or more processors. Responsive to execution of the program instructions, the one or more processors obtain driver-initiated action (DIA) data indicative of a driving maneuver of the principle vehicle and obtains traffic movement related (TMR) data indicative of a course of an object in an environment at least partially around the principle vehicle. The system analyzes the DIA data and TMR data to determine a potential traffic impact (PTI) condition between the principle vehicle and the object and generates a driver notification of the PTI condition.

Optionally, responsive to execution of the program instructions, the one or more processors may calculate the driving maneuver based on the DIA data. The DIA data may be indicative of a driver-initiated action that affects a principle vehicle direction or principle vehicle speed. The PTI condition may relate to a potential impact of the principle vehicle with at least one of a secondary vehicle, motorized vehicle, non-motorized vehicle, animal, or human. The input device may include at least one of, turn signal, radar, infrared sensors, LIDAR, speed sensors, global positioning system, or steering sensor. The output device may be at least one of a tactile system, a haptic system, an auditory system, or a vehicle display.

In accordance with embodiments herein, a computer program product is provided. The computer program product includes a non-signal computer readable storage medium comprising computer executable code to perform obtaining driver-initiated action (DIA) data indicative of a driving maneuver of a principle vehicle and obtaining traffic movement related (TMR) data indicative of a course of an object in an environment at least partially around the principle vehicle. The computer program program product analyzes the DIA data and TMR data to determine a potential traffic impact (PTI) condition between the principle vehicle and the object and generates a driver notification of the PTI condition.

Optionally, the non-signal computer readable storage medium may comprise computer executable code to perform calculating the driving maneuver based on the DIA data, the DIA data indicative of a driver-initiated action that affects a principle vehicle direction or principle vehicle speed. The PTI condition may relate to a potential impact of the principle vehicle with at least one of a secondary vehicle, motorized vehicle, non-motorized vehicle, animal, or human. analyzing the DIA data and TMR data may include at least one of identifying when to turn the principle vehicle, determining whether to increase speed to make a turn, or determining not to turn. Notifying a driver of the PTI condition may include at least one of providing haptic feedback, intermittent light, indicator indicia, color coded display, or audible warning.

### BRIEF DESCRIPTION OF THE DRAWINGS

FIG. 1 illustrates a principle vehicle that includes a collision avoidance system formed in accordance with embodiments herein.

FIG. 1A illustrates a schematic block diagram of a collision avoidance system formed in accordance with embodiments herein.

FIG. 2 illustrates a process for avoiding collisions while navigating along a route in accordance with embodiments herein.

FIG. 3 illustrates a schematic diagram of a principle vehicle preparing to make a driving maneuver in accordance with embodiments herein.

FIG. 4 illustrates a schematic diagram of a principle vehicle preparing to make a driving maneuver in accordance with embodiments herein.

FIG. 5 illustrates a display providing a notification in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments. It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The terms “driver-initiated action data” and “DIA data” shall mean all data, information, signals, or the like that may be obtained by inputs, sensors, or the like for a principle vehicle and that are indicative of actions taken by a driver of the vehicle that affect vehicle direction, speed and the like. Examples of DIA data include, but are not limited to, activation data related to left or right turn signals, changes in steering wheel position, changes in brake position, changes in accelerator position and the like.

The term “traffic movement related data” and “TMR data” shall mean all data, information, signals, or the like that may be automatically obtained by a collision avoidance system that are indicative of a course of an object in an environment at least partially around a principle vehicle. The course of the object is the trajectory of the object assuming the object continues on a current path (e.g., straight, curved, angled, stationary) where the object represents any and all secondary vehicles, motorized vehicles, non-motorized vehicles including bicycles, animals, humans, curbs, traffic signs, barriers, or the like. The TMR data may be obtained from inputs, sensors, or the like of the collision avoidance system or received from remote or secondary devices. TMR data may relate to a “secondary” vehicle in an environment that may affect navigation of the principle vehicle utilizing the collision avoidance system. Examples of TMR data include, but are not limited to, GPS data, routes, maps, visual data captured by cameras including traffic signs, turning lanes, secondary vehicles, or the like, speed, acceleration, and distance of an oncoming secondary vehicle, secondary vehicle to the side of a principle vehicle, or behind the principle vehicle of the operator, speed data, acceleration data, turning radius, vehicle dimensions, road barriers, or the like.

The term “driving maneuver” shall mean one or more potential actions a principle vehicle may take in response to DIA data. For example, a driving maneuver includes, but is not limited to, turning, changing lanes, making U-turns, merging, passing secondary vehicles, or the like.

The term “potential traffic impact condition” or “(PTI) condition” shall mean any and all possible, probable, or prospective collisions, impacts, or crashes, of a principle vehicle within a surrounding area. Example potential traffic impact conditions include, but are not limited to, colliding with a secondary vehicle, including when the principle vehicle initiates the collision and when the secondary vehicle initiates the collision, colliding with a median, colliding with a traffic sign or light, colliding with a pedestrian, colliding with a barrier, engaging a tire against a curb, engaging a tire off-road, or the like.

The term “obtains” and “obtaining”, as used in connection with data, signals, information and the like, include at least one of i) accessing memory of an external device or remote server where the data, signals, information, etc. are stored, ii) receiving the data, signals, information, etc. over a wireless communications link between the base device and a secondary device, and/or iii) receiving the data, signals, information, etc. at a remote server over a network connection. The obtaining operation, when from the perspective of a base device, may include sensing new signals in real time, and/or accessing memory to read stored data, signals, information, etc. from memory within the base device. The obtaining operation, when from the perspective of a secondary device, includes receiving the data, signals, information, etc. at a transceiver of the secondary device where the data, signals, information, etc. are transmitted from a base device and/or a remote server. The obtaining operation may be from the perspective of a remote server, such as when receiving the data, signals, information, etc. at a network interface from a local external device and/or directly from a base device. The remote server may also obtain the data, signals, information, etc. from local memory and/or from other memory, such as within a cloud storage environment and/or from the memory of a personal computer.

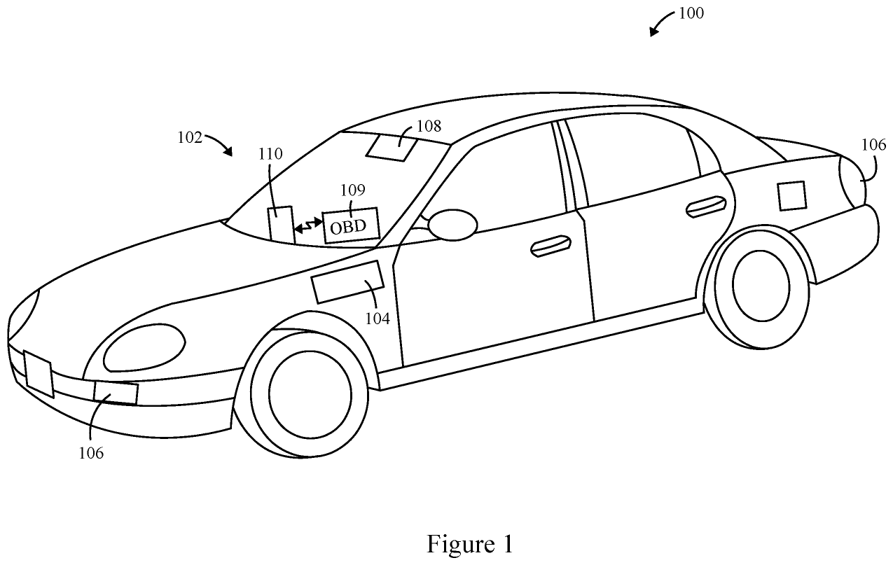

FIG. 1 illustrates a principle vehicle 100 that includes a collision avoidance system 102 formed in accordance with embodiments herein. The collision avoidance system 102 includes one or more processors 104 that obtain driver-initiated action (DIA) data or traffic movement related (TMR) data. The DIA data is analyzed to determine a driving maneuver of the principle vehicle. The DIA data may include actuation of a turn signal, movement of the steering wheel, braking, an increase or decrease in principle vehicle speed, or the like. TMR data is analyzed to determine the course, including trajectory and speed, of one or more objects at least partially in the environment of the principle vehicle 100. The TMR data may include the distance and speed of oncoming secondary vehicles, the lane where oncoming secondary vehicles are located, or the like.

The one or more processors 104 analyze the DIA data and TMR data received from the plural input devices 106 to determine a potential traffic impact (PTI) condition related to the determined driving maneuver. In one example, when the driving maneuver is performing a U-turn, the DIA data may include actuation of a turn signal, movement of the steering wheel, and braking, and the TMR data may include sensor data related to the distance and speed of oncoming secondary vehicles, the lane where oncoming secondary vehicles are located, or the like. Alternatively, the driving maneuver may be making a turn, merging into traffic, or the like. Based on the analysis, one or more output devices 108 notify a driver of the PTI condition determined that are related to the driving maneuver.

The one or more processors 104 may be coupled to an onboard diagnostic (OBD) system 109, a remote device 110, a remote device 110 in communication with the OBD system 109, or integrated as part of the OBD system 109. On-board diagnostics (OBD) is an automotive term referring to a principle vehicle's self-diagnostic and reporting capability. On-Board Diagnostics, is a computer-based system built into all 1996 and later light-duty vehicles and trucks, as required by the Clean Air Act Amendments of 1990. OBD systems are designed to monitor the performance of some of an engine's major components including those responsible for controlling emissions. The OBD system 109 gives the vehicle owner or repair technician access to the status of the various vehicle sub-systems. The amount of diagnostic information available via OBD has varied widely since its introduction in the early 1980s' versions of on-board vehicle computers. Modern OBD system implementations use a standardized digital communications port to provide real-time data in addition to a standardized series of diagnostic trouble codes, or DTCs, which allow one to rapidly identify and remedy malfunctions within the vehicle. In this manner, the OBD system 109 may provide communication pathways to present information to a driver, and may also provide TMR data to be used to provide outputs.

FIG. 1A illustrates a schematic block diagram of the collision avoidance system 102. The collision avoidance system 102 includes input devices 106, output devices 108, and the OBD system 109. Additionally, the one or more processors 104 may be in communication with one or more memories 111 that store instructions executed by the one or more processors and systems herein to analyze the DIA data or TMR data to determine a PTI condition of a driving maneuver, and provide an output to communicate the PTI condition. In one example, the one or more processors 104 analyze the PTI condition utilizing mathematical formulas, including one or more algorithms that calculate or determine the PTI condition based on the obtained DIA data and/or TMR data. Specifically, the one or more processors receive continuous real-time DIA data and/or TMR data to determine a real-time PTI condition of the principle vehicle.

The one or more memories 111 can encompass one or more memory devices of any of a variety of forms (e.g., read only memory, random access memory, static random access memory, dynamic random access memory, etc.) and can be used by the processor 104 to store and retrieve data. The data that is stored by the local storage medium 111 can include, but need not be limited to, operating systems, applications, user collected content and informational data, DIA data, TMR data or the like. Each application includes executable code that utilizes an operating system to provide more specific functionality for the collision avoidance system 102. The memories, or local storage medium 111 may also store content, such as DIA data or TMR data (e.g., past frequent routes), a present GPS route, or the like, saved in common or separate memory sections.

For example, the DIA data may include information regarding non-GPS assisted routes (e.g., the commuter route, school route, and other common routes taken by a principle vehicle during day-to-day life without the need for audible or visual instructions from a GPS device etc.). The routes may be defined by road segments and intersections. Additionally and alternatively, the DIA data may include information regarding certain intersections, such as intersections through which the principle vehicle frequently travels. Certain intersections within the DIA data may be characterized as candidate intersections or candidate turn intersections when there may be a reason for the principle vehicle to turn at the corresponding intersection. For example, when following a GPS assisted route calculated between source and destination locations, the turns along the route represent candidate turn intersections where the route suggests the principle vehicle turn. As a further example, when the principle vehicle is not following a particular route, namely non-GPS assisted routes, candidate turn intersections may also arise. For example, a candidate turn intersection may be identified in connection with non-GPS assisted routes such as when the principle vehicle approaches an intersection saved in the memory as a frequent intersection.

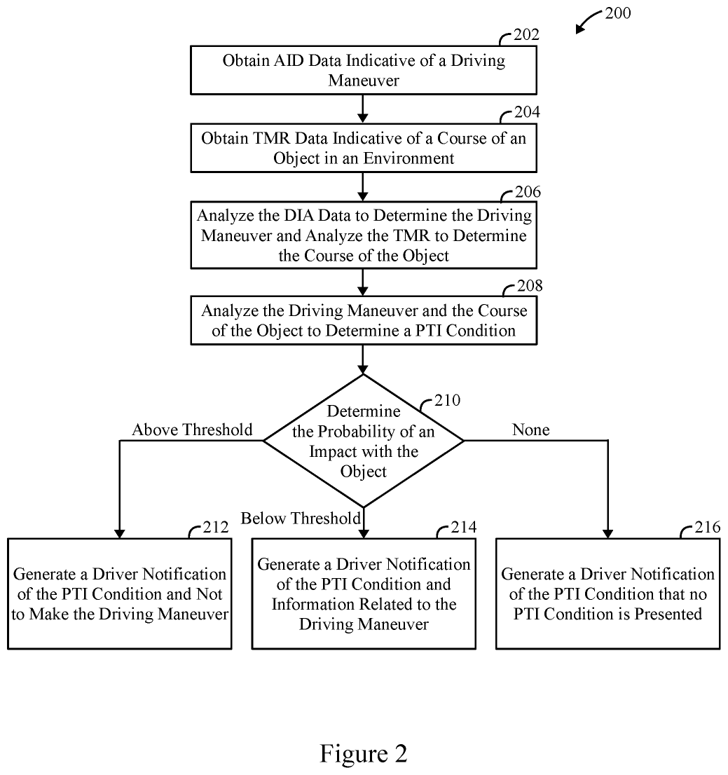

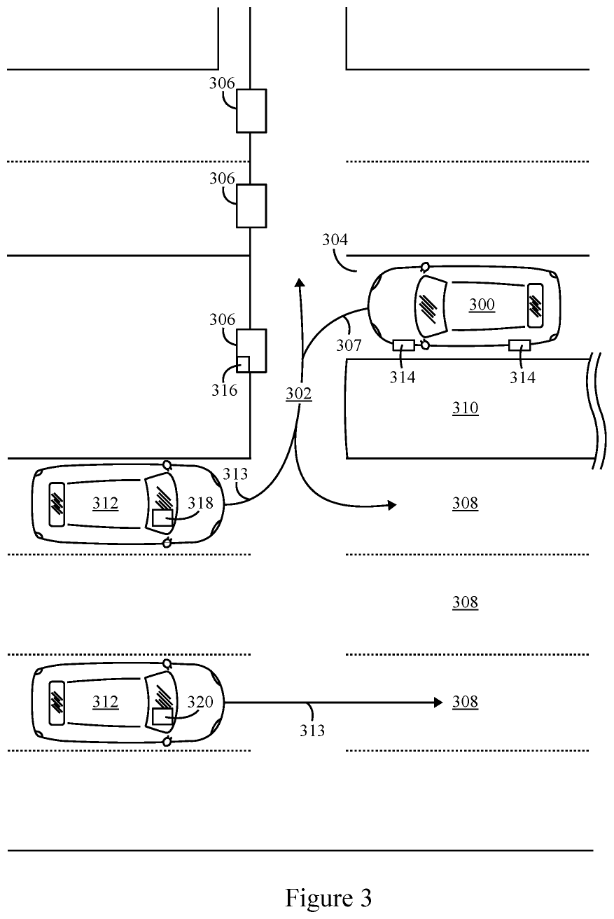

DIA data may become more reliable over time as more events and details are collected concerning driving patterns of a principle vehicle. For example, the DIA data may indicate that when a principle vehicle enters certain intersections from a particular direction at certain times of day, the principle vehicle always turns left. Accordingly, the intersection would be marked as a candidate turn intersection at which the principle vehicle is expected to turn left, and the processes described herein (e.g., in connection with FIGS. 3-4) would operate in an according manner. By utilizing DIA data within a memory along with real-time DIA data, determinations may be made related to when a driving maneuver may occur.

The local storage medium 111 may also stores map information 115 to be used herein. The map information 115 may correspond to a road system for a region or area in which the principle vehicle is located. The map information 115 includes road related data, such as lane restrictions. The map information 115 for a select region may be downloaded to the one or more processors 104, the mobile device 110, within a GPS device 114, or the like and may be updated continuously, periodically, upon demand, or the like. Throughout operation, as the principle vehicle 100 moves to various geographic regions or a user enters destination locations outside of a local geographic region, the one or more processors 104 may download additional road related data.

The plural input devices 106 include a turn signal system 113, GPS device 114, optical system 116, radar 118, LIDAR 120, a transceiver 121, or the like. The GPS device 114 is coupled to the one or more processors and tracks the current position and speed of the principle vehicle 100. As explained hereafter, in accordance with embodiments herein, a route may be created by the GPS device 114 and a position and speed of the principle vehicle may be tracked with the GPS device 114. Similarly, a route of a principle vehicle may also be provided by the GPS device 114. Based on the DIA data, including the route and the current position/speed of the principle vehicle, the one or more processors may make determinations related to driving maneuvers.

The optical system 116, may be a camera, infrared camera, or the like that may receive optical or image based TMR data from the side and front of the principle vehicle 100. Specifically, the optical system 116 may be positioned on the principle vehicle and have a field of view to detect object, including on-coming traffic in an on-coming lane from at least a quarter of a mile away from the principle vehicle over, and at least four lanes of traffic, or approximately 64 feet, to the side of the principle vehicle. In other examples, the optical system 116 is positioned to have coverage at least a quarter of a mile behind the principle vehicle as well.

The one or more processors 104 may also obtain image data from cameras positioned to capture road signs, such as to identify road signs indicating that a lane is a merge lane, a right turn only lane, a left turn only lane, a straight-right lane, a straight-left lane, a U-turn lane, or the like. Similarly, both the radar 118, and LIDAR 120 are positioned to detect at least the same area of coverage, or have the same field of view as the optical system 116. Accordingly, TMR data may be obtained.

Additionally and alternatively, when a GPS device indicates the principle vehicle is on an on-ramp, the one or more processors obtain input from the optical system 116 that provides speed and distance information related to secondary vehicles on the side, and behind the principle vehicle 100. In each example, the one or more processors determine the driving maneuver based on DIA data obtained from the input devices 106 and then determines a notification based on TMR data obtained from the input devices 106.

A transceiver 121 can utilize a known wireless technology for communication. Exemplary operation of the wireless transceivers 121 may take a variety of forms and may include, for example, operation in which, upon reception of wireless signals, detect communication signals from secondary vehicles and the transceiver 121 demodulates the communication signals to recover incoming information, such as secondary vehicle GPS coordinates, secondary vehicle speed data, secondary vehicle route data, or other similar TMR data that may be transmitted by the wireless signals. After receiving the incoming information from the transceiver 121, the one or more processors 104 utilize the information to make determinations regarding a PTI condition related to driving maneuvers. In accordance with embodiments herein, the transceiver 121 may bi-directionally convey GPS related data and information between the collision avoidance system and the control system, including an OBD system of a secondary vehicle.

The output devices 108 may include in principle vehicle display 122, auditory systems 124, tactile systems 126, haptic systems 128, or the like. In this manner, output devices 108 include vehicle seats, steering wheels, dashboards, or the like that may vibrate. The vehicle display 122 may be a built-in display screen that may be utilized to provide route information, including GPS mapping. Alternatively, the vehicle display 122 may be included as part of a dashboard display that displays an odometer, mileage, or the like. In one example, the dashboard display is a digital display that may communicate information to the driver. In another example, the vehicle display is a liquid crystal display screen. In yet another example, the vehicle display is not integrated into the principle vehicle, and instead is a standalone device. In one example, the stand alone device is a mobile GPS device that may be connected to the one or more processors 104 through a communication port, including a USB port. The visual outputs of the output devices may include flashing or intermittent lights, indicator indicia including “STOP” and “GO”, color codes such as red, yellow, and green, or the like. In another example, the vehicle display 122, may include a keypad, selection soft buttons, switch, touchpad, touch screen, icons on a touch screen, a touch sensitive areas on a touch sensitive screen and/or any combination thereof to provide inputs into the collision avoidance system 102. These inputs may include notification preferences, route destinations, on/off commands, voice commands, or the like. In one embodiment, the driver may input a notification preference of a vibrating steering wheel to indicate a turn is either safe, or unsafe. Additionally and alternatively, a drive may input a notification preference of a color coded display 122 that is green when a driving maneuver, such as a turn is safe, and green when the driving maneuver is not safe.

The auditory system 124 may include a microphone, sounds made by the radio, dashboard or the like. The sounds may include beeps, voice commands, including “no turn”, “free to turn”, or the like, warning tone(s), or the like. In one example, the distance between beeps is representative of the distance between the principle vehicle 100 and an oncoming secondary vehicle.

The tactile system 126 and/or haptic system 128, may include vibration or movement of different systems of the principle vehicle 100. From example, vibrations may occur at the steering wheel, vehicle seat, dashboard, or the like. In this manner, the vibration may be felt by an individual driving the principle vehicle, or the vibration may be seen. In either case, the vibration may alert the driver a driving maneuver is safe to perform, or not safe to perform.

The collision avoidance system 102 may optionally include a remote device 110. The mobile device 110 may communicate with the onboard diagnostic (OBD) system 109 through an OBD terminal. The mobile device 110 may include a GPS subsystem. Optionally, the mobile device 110 may communicate with an output device 108, including a stand-alone mobile GPS. Optionally, the mobile device 110 may communicate with a built-in GPS system integrated within the control system of the principle vehicle 100 through a Bluetooth link, another wired connection, or other available communications protocols/links. In accordance with embodiments herein, a route may be created by a GPS device/system and a position and speed of the principle vehicle may be tracked with the GPS device/system. Based on the route and the current position/speed of the principle vehicle, the mobile device 110 determines driving maneuvers based on DIA data obtained.

In accordance with embodiments herein, the mobile device 110 may operate without preset routes. The GPS device/system 114 tracks the current position and speed of the principle vehicle 100, while the mobile device 110 may monitor which lane of traffic that the principle vehicle 100 is located. When the principle vehicle 100 is in a turn only lane and approaching a turn, the mobile device 110 determines the principle vehicle is going to make a principle vehicle maneuver of either making a left turn or making a U-turn. The one or more processors 104 may then make determinations based on collected TMR data regarding a course of one or more objects at least partially in the environment and provide an output to notify or alert a driver accordingly. This notification may be provided as described, or through the mobile device 110, including through auditory signals, visual signals, vibrations, or the like.

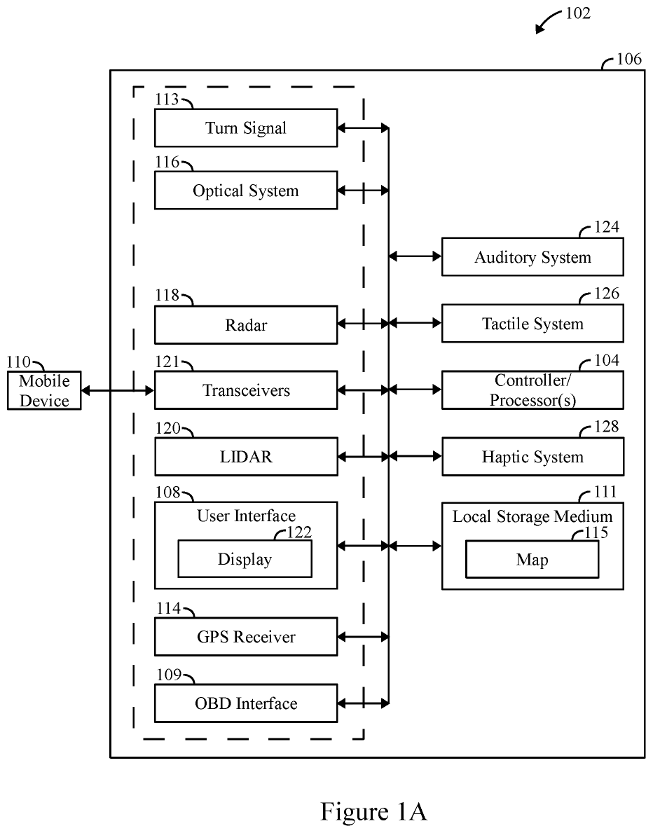

FIG. 2 illustrates a process 200 of generating a driver notification of a PTI condition determined related to a driving maneuver. PTI conditions may include the collision with a secondary vehicle, collisions with road signs, barriers, or stop lights, engaging a tire with curb or off-road, or the like. Driving maneuvers may include U-turns, left turns, right turns, merging into traffic from an on-ramp, or the like.

At 202, one or more processors obtain DIA data indicative of a driving maneuver. In one example, DIA data is obtained from input devices, that in one example are input devices 106 of FIG. 1. The input devices 106 may include a turn signal system, GPS device, optical system, radar, LIDAR, steering sensor, speed sensor, infrared sensors, a transceiver, or the like. In one example, the DIA data may be a left turn signal or right turn signal of a turn signal system being activated. In yet another example, route data is continuously recorded to provide route data within a memory that may be communicated to the one or more processors at a later time. The route data may then be analyzed for driver based patterns related to different routes the driver frequently drives.

At 204, the one or more processors obtain traffic movement related (TMR) data indicative of a course of an object in an environment at least partially around the principle vehicle. The course of an object may be the trajectory of the object assuming the object continues on a current path (e.g., straight, curved, angled, stationary) where the object represents any and all secondary vehicles, motorized vehicles, non-motorized vehicles including bicycles, animals, humans, curbs, traffic signs, barriers, or the like. In example embodiments, the course is the straight line of an oncoming vehicle within another lane, a curved path of a secondary vehicle that is turning, the angled path of a secondary vehicle that is changing lanes, or the like. The TMR data may be obtained from inputs, sensors, or the like of the collision avoidance system or received from remote or secondary devices.

In another example, the TMR data includes visual data, including traffic signs, turning lanes, secondary vehicles, or the like detected by the optical system. Similarly, the radar and LIDAR systems may provide TMR data related to secondary vehicles and may be used to determine the speed, position, and distance of an oncoming secondary vehicle, secondary vehicle to the side of a principle vehicle, or behind the principle vehicle. In another example, the transceiver communicates with a remote device associated with a secondary vehicle to receive TMR data, including global position data of a secondary vehicle, speed related data of a secondary vehicle, acceleration related data of a secondary vehicle, directional data of a secondary vehicle, or the like. The remote device may be a mobile device within the secondary vehicle, or associated with a street sign, construction equipment, or the like that may detect TMR data associated with secondary vehicles.

At 206, one or more processors analyze the DIA data to determine the driving maneuver and analyze the TMR data to determine the course of the object. In one example, the one or more processors receive DIA data that a left turn signal is activated from a turn signal system. Optionally, the one or more processors may obtain principle vehicle position (PVP) data that the principle vehicle is in a left turn lane based on optical data from an infrared camera. In another example, based on the DIA data (alone or in combination with the PVP data), a determination is made the driving maneuver is a U-turn, because historical route data within a memory is received by the one or more processors that indicates that on average, the principle vehicle makes a U-turn at this intersection at least 3 times a week. In yet another example, a determination is made that the driver is merging into traffic, based on a GPS device that indicate the principle vehicle is on an on-ramp. In one example, the driving maneuver is determined by calculating the driving maneuver based on the DIA data, the DIA data indicative of the driver-initiated action that affects a principle vehicle direction or principle vehicle speed. DIA data is analyzed using mathematical formulas, including algorithms, comparing DIA data to DIA data previously recorded within the memory, comparing DIA data to threshold values stored in a memory, or the like.

The one or more processors also analyze the TMR data to determine a course of the object. In one example, the one or more processors receive position data, speed data, acceleration data, heading data, or the like related to one or more objects from input devices. Based on this TMR data the trajectory and speed of each object may be determined. In one example, the trajectory and speed are determined through using mathematical formulas, including algorithms, comparing TMR data to TMR data previously recorded within the memory, comparing TMR data to threshold values stored in a memory, or the like. In one embodiment, TMR data is analyzed to determine two objects are within the environment. In one example, the driving maneuver of the primary vehicle is a U-turn onto a multi-lane roadway that includes a first secondary vehicle and a second secondary vehicle that are both oncoming traffic. The one or more processors receive TMR data related to each of the first secondary vehicle and second secondary vehicle. In this manner, the one or more processors analyze the TMR data associated with each secondary vehicle to determine a first course related to the first secondary vehicle, and a second course related to the second secondary vehicle. Specifically, the one or more processors determine trajectory and speed associated with the course of the first secondary vehicle, and determine the trajectory and speed associated with the course of the second secondary vehicle. Optionally, during the analysis, weights are associated with each of the first course and second course to identify the secondary vehicle most likely to collide with the primary vehicle based on the determined course. In one example, the one or more processors determine a critical path between the first secondary vehicle and second secondary vehicle. A critical path represents the course of the object most likely to be involved in a collision with the primary vehicle. While in this example two secondary vehicles are presented, in other embodiments additional secondary vehicles, and/or other objects may be presented.

At 208, the one or more processors analyze the driving maneuver and the course of the object to determine a PTI condition. Analyzing the driving maneuver and course of the object may include at least one of identifying when to turn the principle vehicle, determining whether to increase speed to make a turn, or determining not to turn. Determining the PTI condition related to the driving maneuver also includes calculating the trajectory of an object, such as a secondary vehicle along a course or pathway. For example, in one embodiment, when the driving maneuver is a left turn, the one or more processors may utilize optical systems, radar, or LIDAR reading to determine the speed, distance, and acceleration of secondary vehicles that are in an on-coming lane that must be crossed to determine the trajectory, course, or pathway of each vehicle over time. This includes determining position related data and time related data. In another example, based on this DIA data, along with DIA data within a memory related to principle vehicle turning radius, principle vehicle turning speed, principle vehicle length, or the like, the one or more processors determine the PTI condition by determining the trajectory, course, or pathway of the principle vehicle including position data, speed data, and time data. In an example, a determined course of the object is compared to a determined course of the primary vehicle as a result of executing the driving maneuver to determine the PTI condition.

In another example, when a determination is made that a U-turn is the driving maneuver, the one or more processors, may use optical systems, radar, or LIDAR to determine a PTI condition related to the maneuver, including but not limited to speed, distance, and acceleration of secondary vehicles that are in on-coming lanes that may potentially be turned into. DIA data related to the principle vehicle, including principle vehicle turning radius, principle vehicle turning speed, principle vehicle length, or the like, may also be used. In addition, TMR data related to the location and speed of on-coming secondary vehicles within lanes that a principle vehicle may turn into may also be utilized to determine the PTI condition related to the maneuver. In this manner, the PTI conditions may include impact from the on-coming secondary vehicle, likelihood an on-coming secondary vehicle will have to reduce its speed, or the like.

In yet another example, when a determination is made that merging into traffic is the driving maneuver, the one or more processors again, may use optical systems, radar, or LIDAR to determine a PTI condition related to the maneuver, including but not limited to speed, distance, position, and acceleration of objects such as secondary vehicles on a roadway or on ramp in proximity to the principle vehicle. Consequently, the input device may provide inputs related to behind, and to the side, of the principle vehicle in order to make determination related to the best manner to merge into traffic. Based on the DIA data and/or TMR data, the PTI condition may be determined.

At 210, the one or more processors determine the probability of an impact with the object. The determination includes calculating characteristics of driving maneuvers of the principle vehicle, characteristics of the course(s) of the object(s), the effect the driving maneuvers of the principle vehicle have on the object, and the effect of changes in course of the object will have on the principle vehicle. The characteristics of the driving maneuver include the speed at which a turn may be completed by the principle vehicle, the number of lanes available for turning, the turning radius of the principle vehicle, the speed of the principle vehicle, or the like. The characteristics of the course(s) of the object(s) include the speed of the object, the path of the object, including whether the path is straight, angled, curved, or if the object(s) is stationary, or the like. Based on this information, the one or more processors determine a likelihood of impact from an on-coming secondary vehicle, likelihood an oncoming secondary vehicle will have to reduce its speed upon the driver executing the maneuver, or the like. In this manner, risk levels may be determined, including high risk, medium risk, and low risk for maneuvers. Similarly, tolerances are determined associated with each risk level. In one example thresholds are associated with the high risk level and medium risk level to warn a drive not to make a driving maneuver in the high risk level.

If at 210, a determination is made that the probability for impact is above a threshold, or in at a high risk level, at 212, the one or more processors generate a driver notification of the PTI condition, and specifically a notification not to make the driving maneuver. In one example, when a determination is made based on the DIA data and/or TMR data that a greater than 50% chance of a collision may occur, a display within the principle vehicle may display the word “STOP” or “NO TURN”. In another example, these words are displayed with a red background, or a flashing background. Alternatively or additionally, a voice command is provided that states “NO TURN”, or “NO MERGE”. Tactile or haptic feedback, including vibration of the steering wheel or seat of the driver may also be utilized as a notification.

If at 210, a determination is made that a probability for impact exists; however, the probability for impact is below the threshold, or at a medium risk, at 214, the one or more processors generate a driver notification of the PTI condition, and a notification that includes information related to the driving maneuver. In one example, the notification to the driver may be outputting the PTI condition on indication indicia on a display screen, including “30% impact probability”, the driver may be notified of an unfavorable PTI condition in numerous ways without displaying the PTI condition on a screen, or communicating an auditory message of the PTI condition. Instead, in one example, a display may flash intermittently in accordance with a likelihood of impact, with the higher probability of impact resulting in more rapid flashing. In yet other examples, indicator indicia indicate the speed at which the turn needs to be made, instructs the driver to “SPEED UP”, or the like. A color such as yellow may also be used to indicate the driving maneuver may be made, but needs to be made with caution by the driver. In one example, as the one or more processors continue receiving DIA data and/or TMR data, the one or more processor may change the notification to indicate the vehicle should stop, or not make the turn as discussed in relation to 212.

In another example, an audible noise such as a beep, tone, or the like may be used when a driving maneuver is considered safe, or when a driving maneuver is considered dangerous. In embodiments when the audible noise is provided to indicate a driving maneuver is considered dangerous, the audible noise may increase in volume in response to an increase in danger of an impact occurring.

In another example, tactile or haptic feedback is provided to the driver, to indicate either a safe driving maneuver, or in opposite a driving maneuver has the risk of being dangerous. Therefore, in one example, the seat of the driver may vibrate when a driving maneuver is considered dangerous, or not recommended. Alternatively, the seat of the driver may vibrate when the driving maneuver is considered safe, to alert a driver the maneuver should be undertaken. In another example, the steering wheel vibrates to provide the notification. In yet another example, a dashboard, or gear stick may vibrate, again to indicate either a PTI condition, or the absence of a PTI condition.

If at 210, a determination is made that there is no probability for impact, at 216, the one or more processors generate a driver notification that no PTI condition is presented. In one example, when a vehicle is merging into traffic, and no traffic is on a highway, a display in the vehicle may provide indication indicia such as “GO”, “SAFE MERGE”, “CLEAR”, or the like. Similarly, a color such as green may be displayed. Auditory, haptic, tactile, or the like notification may similarly be generated to notify the drive the driving maneuver is safe to make.

As and after the notification is generated, the one or more processors go back to 210 to and repeat this process. The process is continuously repeated so that the notification may be continuously updated as the PTI condition related to the driving maneuver changes, including distances between the principle vehicle and object, and the speed of objects such as secondary vehicles. The process continues to repeat until the driving maneuver is complete. As a result, the driver is continuously updated to receive as much information as possible during a driving maneuver to avoid a collision.

FIG. 3 illustrates a schematic diagram of an example principle vehicle 300 utilizing the collision avoidance system 102 of FIG. 1. In one example, the principle vehicle 300 is principle vehicle 100 of FIG. 1. In the example, the principle vehicle 300 is stopped at an intersection 302 within a left-hand turn lane 304 and is stopped at a stop light 306 with a left turn signal activated. The driver desires to make a U-turn along a principle vehicle course 307, or pathway, into a driving lane 308 on the other side of the shoulder 310 as indicated by a GPS device in the vehicle. An on-coming secondary vehicle 312 approaches the intersection 302 traveling in a direction opposite along a secondary vehicle course 313, or pathway, to which the principle vehicle 300 is pointing.

In this example, the collision avoidance system obtains DIA data related to the primary vehicle having an activated left turn signal and a GPS route that indicates a U-turn. The DIA data is analyzed to determine that the primary vehicle is making a U-turn as a driving maneuver.

The principle vehicle 300 includes a sensor system 314 that detects object in the environment including the on-coming secondary vehicles 312. The sensor system 314 may include a camera system, infrared camera, 3-dimensional camera, radar, LIDAR, or the like that detects the on-coming secondary vehicles 312 and detects TMR data related to the secondary on-coming vehicles 312 to allow real-time determination to be made related to the speed, acceleration, distance, likelihood of impact, time to impact, distance to impact, or the like, if the principle vehicle 300 makes a U-turn, or the like. Alternatively, remote sensors 316 may transmit TMR data to the collision avoidance system 102. In yet another example, mobile devices 318 within the on-coming secondary vehicles 312, or onboard devices 320 may communicate TMR data to the collision avoidance system. Based on the TMR data, one or more processors of the collision avoidance system 102 may determine the secondary vehicle course 313 of each secondary vehicle. By determining the driving maneuver and the course of each secondary vehicle, the sensor system 314 determines a PTI condition related to making the U-turn, and generates an output notification to the driver of the PTI condition is provided as discussed herein. In this example, the sensor system 314 would determine the secondary vehicle 312 nearest the principle vehicle 300 is on a critical path and the generate a notification not to make the driving maneuver.

FIG. 4 illustrates a schematic diagram of an example principle vehicle 400 utilizing the collision avoidance system 102 of FIG. 1. In one example, the principle vehicle 400 is principle vehicle 100 of FIG. 1. In the example, the principle vehicle 400 is on an on-ramp 402 and merging into secondary vehicles 404 on a highway 406. The on-ramp 402 includes solid merge lane lines 408, and the highway includes dashed lane lines 410. The driver actuates the left-hand turn signal to merge.

In this example, the DIA data is obtained related to the activation of the left-hand turn signal and position on the highway. Based on an analysis of this DIA data a determination is made that the principle vehicle 400 is merging into traffic.

The principle vehicle includes a sensor system 414 that detects objects, including the secondary vehicles 404 in front of the principle vehicle 400, on the on-ramp 402, behind the principle vehicle 400, and on the side of the principle vehicle 400 to obtain TMR data. The sensor system 414 may include a camera system, infrared camera, 3-dimensional camera, radar, LIDAR, or the like that detects the secondary vehicles 404 and detects conditions of the secondary vehicles 404 to allow a real-time determination to be made related to the speed, acceleration, distance, likelihood of impact, time to impact, distance to impact, or the like, if the principle vehicle 400 attempts to move over from the on-ramp 402 and into a lane of the highway 406. Alternatively, remote sensors 416, such as one on a road sign 417, such as a mile marker or speed limit sign, may transmit similar TMR data to the collision avoidance system 102. In yet another example, a mobile device 418 within secondary vehicle 404, or an onboard device 420 may communicate similar TMR data to the collision avoidance system. Based on the TMR data, one or more processors of the collision avoidance system 102 may determine a PTI condition related to merging on the highway, and an output notification to the driver of the PTI condition is provided as discussed herein. In one example, one or more processors determine based on the speed and acceleration of the principle vehicle 400 and the speed of the secondary vehicles 404, no probability of collision exists, and “MERGE NOW” is displayed on a screen in the principle vehicle 400.

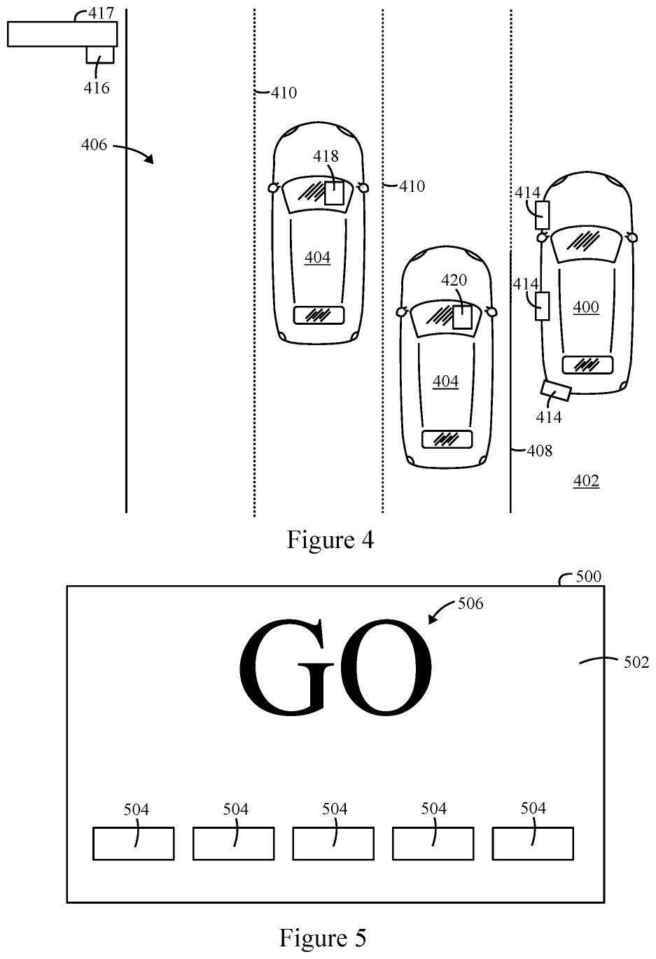

FIG. 5 illustrates a display 500 generating an example notification for a driver of a principle vehicle. In one example the display 500 is an output device 108 of FIG. 1. The display 500 includes a screen 502 that includes inputs 504. The inputs in one example are touch screen buttons that may be utilized to provide notification preferences to a driver. Notification preferences may include visual notifications including color coding, indication indicia, intermittent light, or the like, audio or auditory notifications including intermittent beeps, voice commands, or the like, haptic or tactile notifications including vibration of a steering wheel, vehicle seat, dashboard, or the like, or the like. In this example, indication indicia 506 “GO” is displayed on the display 500 in order to provide the notification. In alternative examples the number of seconds to make a turn, the minimum speed at which to make a turn, or the like may be provided as the notification. By providing the notification, a driver may be alerted of a collision, allowing the driver to change their actions and prevent the collision.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon. Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing. Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally and alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A computer implemented method, comprising:
under control of one or more processors configured with specific executable program instructions,
obtaining driver-initiated action (DIA) data indicative of a driving maneuver of a principle vehicle;
obtaining traffic movement related (TMR) data indicative of a course of an object in an environment at least partially around the principle vehicle;
analyzing the DIA data and TMR data to determine a potential traffic impact (PTI) condition between the principle vehicle and the object; and
generating a driver notification of the PTI condition.

2. The method of claim 1, further comprising calculating the driving maneuver based on the DIA data, the DIA data indicative of a driver-initiated action that affects a principle vehicle direction or principle vehicle speed.

3. The method of claim 2, wherein the PTI condition relates to a potential impact of the principle vehicle with at least one of a secondary vehicle, motorized vehicle, non-motorized vehicle, animal, or human.

4. The method of claim 1, wherein analyzing the DIA data and TMR data includes at least one of identifying when to turn the principle vehicle, determining whether to increase speed to make a turn, or determining not to turn.

5. The method of claim 1, wherein obtaining TMR data includes receiving the TMR data from at least one vehicle input device coupled to the one or more processors.

6. The method of claim 5, wherein the at least one vehicle input device includes at least one of, turn signal, radar, infrared sensors, LIDAR, speed sensors, global positioning system, or steering sensor.

7. The method of claim 1, wherein the TMR data includes at least one of secondary vehicle speed, amount of turn lanes, secondary vehicle direction, or secondary vehicle distance.

8. The method of claim 1, wherein notifying a driver of the PTI condition includes at least one of providing haptic feedback, intermittent light, indicator indicia, color coded display, or audible warning.

9. The method of claim 8, wherein providing haptic feedback includes at least one of vibrating a seat or vibrating a steering wheel of the principle vehicle.

10. The method of claim 1, wherein the driving maneuver is one of merging into traffic, making a U-turn, or making a left turn.

11. A system, comprising:
a principle vehicle;
one or more processors related to the principle vehicle;
an input device coupled to the one or more processors;
a local storage medium storing program instructions accessible by the one or more processors;
wherein, responsive to execution of the program instructions, the one or more processors:
obtain driver-initiated action (DIA) data indicative of a driving maneuver of the principle vehicle;
obtain traffic movement related (TMR) data indicative of a course of an object in an environment at least partially around the principle vehicle;
analyze the DIA data and TMR data to determine a potential traffic impact (PTI) condition between the principle vehicle and the object; and
generate a driver notification of the PTI condition.

12. The system of claim 11, wherein, responsive to execution of the program instructions, the one or more processors calculate the driving maneuver based on the DIA data, the DIA data indicative of a driver-initiated action that affects a principle vehicle direction or principle vehicle speed.

13. The system of claim 12, wherein the PTI condition relates to a potential impact of the principle vehicle with at least one of a secondary vehicle, motorized vehicle, non-motorized vehicle, animal, or human.

14. The system of claim 11, wherein the input device includes at least one of, turn signal, radar, infrared sensors, LIDAR, speed sensors, global positioning system, or steering sensor.

15. The system of claim 14, wherein the output device is at least one of a tactile system, a haptic system, an auditory system, or a vehicle display.

16. A computer program product comprising a non-signal computer readable storage medium comprising computer executable code to perform:
obtaining driver-initiated action (DIA) data indicative of a driving maneuver of a principle vehicle;
obtaining traffic movement related (TMR) data indicative of a course of an object in an environment at least partially around the principle vehicle;
analyzing the DIA data and TMR data to determine a potential traffic impact (PTI) condition between the principle vehicle and the object; and
generating a driver notification of the PTI condition.

17. The computer program product of claim 16, wherein the non-signal computer readable storage medium comprising computer executable code to perform:
calculating the driving maneuver based on the DIA data, the DIA data indicative of a driver-initiated action that affects a principle vehicle direction or principle vehicle speed.

18. The computer program product of claim 17, wherein the PTI condition relates to a potential impact of the principle vehicle with at least one of a secondary vehicle, motorized vehicle, non-motorized vehicle, animal, or human.

19. The computer program product of claim 16, wherein analyzing the DIA data and TMR data includes at least one of identifying when to turn the principle vehicle, determining whether to increase speed to make a turn, or determining not to turn.

20. The computer program product of claim 16, wherein notifying a driver of the PTI condition includes at least one of providing haptic feedback, intermittent light, indicator indicia, color coded display, or audible warning.
